(19) United States
(12) Patent Application Publication
(10) Pub. No.: US 2013/0052404 A1
(43) Pub. Date: Feb. 28, 2013

(54) BUNTING AND METHOD OF MANUFACTURE

(71) Applicant: Lee Capozzi, Ridgefield, NJ (US)

(72) Inventor: Lee Capozzi, Ridgefield, NJ (US)

(73) Assignee: Dan-Dee International, Ltd., Jersey City, NJ (US)

(21) Appl. No.: 13/218,912

(22) Filed: Aug. 26, 2011

(51) Int. Cl. B32B 3/28; D05B 1/00; D04H 3/04; B32B 3/06

(52) U.S. Cl. 428/100; 428/181; 112/475.01; 28/100

(57) ABSTRACT

An ornamental bunting that may include a length of textile folded to form a plurality of pleats, the length of textile including a top edge, a bottom edge, a first lateral side, and a second lateral side; a first coupling member adapted to attach each of the plurality of pleats at a location between the first lateral side and the second lateral side; and a second coupling member adapted to attach a first bottom portion of the bottom edge with a second bottom portion of the bottom edge.

### FIELD OF THE INVENTION

The present invention generally relates to an ornamental bunting and methods of manufacture. More particularly, the present invention relates to an ornamental bunting formed from a length of a textile and a method of making the ornamental bunting.

### BACKGROUND

Ornamental buntings of the type typically seen at events associated with festivities, such as the Fourth of July or the World Series, are formed by folding generally rectangular fabric, usually decorated brightly, into pleats and securing the pleats at one end. Typical forms of bunting are lengths of fabric in the colors of national flags gathered and draped into swags or pleated into fan shapes.

In some cases, the pleats are secured at one end by passing a metal ring through grommets installed in apertures in each of the pleats, allowing the opposite end to be spread out in a fan shape. Alternative methods of securing the pleats at the one end include using metal toothed clamps.

### SUMMARY

In exemplary embodiments, there is provided a bunting that may include a length of textile folded to form a plurality of pleats, the length of textile comprising a top edge, a bottom edge, a first lateral side, and a second lateral side. The bunting may include a first coupling member adapted to attach each of the plurality of pleats at a location between the first lateral side and the second lateral side and a second coupling member adapted to attach a first bottom portion of the bottom edge with a second bottom portion of the bottom edge.

In exemplary embodiments, there is provided a method of manufacturing a bunting that may include providing a length of a textile including a top edge and a bottom edge, the bottom edge comprising a first bottom portion and a second bottom portion; folding the length of textile into a plurality of pleats, the plurality of pleats including a first lateral side and a second lateral side; attaching each of the plurality of pleats at a location between the first lateral side and the second lateral side with a first coupling member; and attaching the first bottom portion of the bottom edge and the second bottom portion of the bottom edge with a second coupling member.

In exemplary embodiments, there is provided a bunting kit that may include a length of textile folded to form a plurality of pleats, the length of textile comprising a top edge, a bottom edge, a first lateral side, and a second lateral side. The bunting kit may include a first coupling member adapted to attach each of the plurality of pleats at a location between the first lateral side and the second lateral side and a second coupling member adapted to attach a first bottom portion of the bottom edge with a second bottom portion of the bottom edge. The bunting kit may further include a hanger member adapted to support the weight of the bunting, the hanger member attached to the length of the textile, and a securing band adapted to secure the textile in a gathered condition wherein the plurality of pleats are folded.

These and other features of this invention are described in, or are apparent from, the following detailed description of various exemplary embodiments of the invention.

### BRIEF DESCRIPTION OF THE DRAWINGS

The features and advantages of the present invention will be more fully understood with reference to the following detailed description of various exemplary embodiments when taken in conjunction with the accompanying figures, wherein:

FIG. 1 is a perspective view illustrating an exemplary textile that may be used to form a bunting in accordance with embodiments of the present invention;

FIG. 2 is a perspective view illustrating an exemplary textile that may be used to form a bunting in accordance with embodiments of the present invention;

FIG. 3 is a perspective view illustrating an exemplary textile that may be used to form a bunting, folded into a plurality of pleats in a gathered condition in accordance with embodiments of the present invention;

FIG. 4 is a perspective view illustrating an exemplary textile that may be used to form a bunting, folded into a plurality of pleats in a semi-expanded position in accordance with embodiments of the present invention;

FIG. 5 is a perspective view illustrating an exemplary bunting in accordance with embodiments of the present invention; and

FIG. 6 is a flow diagram illustrating an example flow for carrying out exemplary embodiments of the present invention.

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

### DETAILED DESCRIPTION

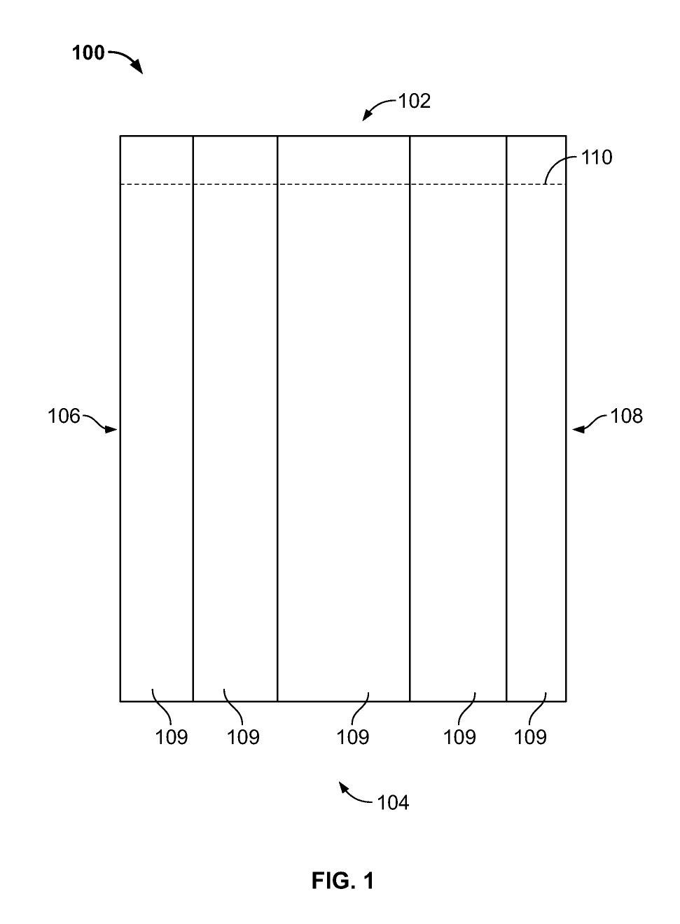

The following detailed description generally describes various exemplary embodiments of the present invention, as depicted in FIGS. 1-6, and should not be considered limiting to other equally effective embodiments, as understood to those of ordinary skill in the art.

In the following detailed description, numerous specific details are set forth in order to provide a thorough understanding of embodiments or other examples described herein. In some instances, well-known methods, procedures, and components have not been described in detail, so as to not obscure the following description. Further, the examples disclosed are for exemplary purposes only and other examples may be employed in lieu of, or in combination with, the examples disclosed.

Exemplary embodiments of the present invention generally relate to a bunting and methods of manufacture. As shown in FIGS. 1-7, exemplary embodiments may include a bunting comprising a textile. However, it should be understood non-textile bunting and methods of manufacture are contemplated by and within the scope of the present invention.

As used herein, the term “textile” may include, without limitation, all fabrics containing natural or synthetic fibers, and all blends made from these fibers. As shown in the exemplary embodiments depicted in the figures, embodiments of the present invention may comprise materials including fabric. Alternative materials, having similar properties, are also contemplated by embodiments of the present invention. Such exemplary materials may include: paper, cellulose products, polymer materials, biodegradable plastics (i.e., bioplastics or petroleum-based plastics), or the like.

As used herein the term “pleat” may generally refer to a section of textile or other material which has been folded back upon itself. In exemplary embodiments, a pleat may be a single pleat, a double pleat, a triple pleat, or the like. Exemplary types of pleats may include, for example, a box pleat, an accordion pleat, a cartridge pleat, a fluted pleat, a Fortuny pleat, a honeycomb pleat, a knife pleat, an organ pleat, a Plissé pleat, a rolled pleat, a Watteau pleat, an inverted pleat, or the like. In exemplary embodiments, pleats may completely or partially overlap. In alternative exemplary embodiments, pleats may not overlap.

Exemplary embodiments may include a bunting that reduces or eliminates the need for rings, clamps, and other excess product materials. As such, exemplary embodiments may provide many benefits, such as, for example: reduced energy consumption and cost, reduced environmental pollutants, reduced raw material consumption and cost, reduced manufacturing cost, reduced waste, reduced shipping cost, reduced shelf space and associated storage cost, increased safety, and increased durability.

A number of the benefits provided by exemplary embodiments relate to reduction of waste and the resulting positive environmental impact. Due to mounting global concerns about the state of the environment, it has become increasingly important for manufacturers to adopt eco-friendly methods of operation. One area in which manufacturers may be able to reduce their “carbon footprint” is the reduction of excess product materials. Several billion tons of excess product materials are buried in landfills each year. This creates a large waste mass that may impede the flow of ground water and obstruct the movement of roots, thereby negatively affecting the biological balance and organic processes of the surrounding soil. Exemplary embodiments of the present invention may lessen the environmental impact of the bunting manufacturing process by reducing or eliminating excess product materials, such as rings, clamps, or the like.

Similarly, exemplary embodiments of the present invention may lessen the environmental impact of the bunting manufacturing process by reducing or eliminating the need to procure and process excess raw materials. The manufacturing process required to make rings, clamps, or the like requires procuring and processing of excess raw materials. This may negatively impact the environment by expending both excess raw materials and the energy resources required to procure and process them. By reducing the need to procure and process raw materials required to manufacture excess product materials such as rings, clamps, or the like, exemplary embodiments of the present invention may significantly reduce the amount of energy and raw materials needed to manufacture a bunting. Accordingly, embodiments of the present invention may lessen the environmental impact of the bunting manufacturing process.

In addition, exemplary embodiments may provide many pecuniary benefits. For example, shipping and storing costs may be reduced by employing exemplary embodiments of the present invention. By eliminating the need for plastic or metal rings, clamps, or the like, embodiments of the present invention may reduce the weight of a bunting and the amount of storage and shelf space required to store and display a bunting. As such, shipping and storage costs may be reduced.

Further, embodiments of the present invention may improve the durability of a bunting. Metal rings, clamps, or the like frequently rust and corrode when exposed to the elements outdoors. Bunting is generally displayed in outdoor locations, and thus, bunting comprising metal rings and clamps may be less durable than bunting that does not require metal rings and clamps, such as a bunting in accordance with exemplary embodiments of the present invention. Accordingly, embodiments of the present invention may improve the durability of a bunting.

Additionally, exemplary embodiments of the present invention may reduce the risk of injury to small children or other individuals handling a bunting. Using metal rings and clamps may place small children and other individuals at a higher risk of injury, because the metal rings and clamps typically consist of a rigid construction and may include sharp edges. It will be readily understood by one having skill in the art that rigid metal rings and clamps with sharp edges may pose a safety hazard to small children and other individuals. Exemplary embodiments of the present invention may reduce or eliminate the need for rigid metal rings and clamps, thereby reducing the risk of injury to small children or other individuals.

As can be understood from the foregoing, exemplary embodiments may reduce energy consumption and cost, reduce environmental pollutants, reduce raw material consumption and cost, reduce manufacturing cost, reduce waste, reduce shipping cost, reduce required shelf space and associated storage cost, increase child safety, and increase durability of a bunting.

FIG. 1 is a perspective view illustrating an exemplary length of textile 100 that may be used to form a bunting in accordance with embodiments of the present invention. Generally, the bunting may include the length of textile 100 including a plurality of sections of textile 109. In exemplary embodiments, each of the plurality of sections of textile 109 may comprise a separate piece of textile. Alternatively, the plurality of sections of textile 109 may comprise a single sheet delineated by color, thread type, material, image, shading, or the like. Generally, each of the plurality of sections of textile 109 may be attached together by any attachment means feasible in accordance with embodiments of the present invention, including, but not limited to one or more stitches, hook-and-loop fasteners (e.g., Velcro®), one or more adhesive strips, buckles, buttons, clasps, clips, pegs, pins, snaps, straps, ties, zippers, any other attachment means, and combinations thereof.

Although five sections of textile 109 are depicted in FIG. 1, any number of sections of textile is contemplated in exemplary embodiments of the present invention. Generally, at least two of the sections of textile 109 may comprise different colors. For example, two sections may be colored red, two sections may be colored white, and one section may be colored blue. With the red, white and blue coloring as described, the resulting bunting may be especially suitable for use as a decoration on a patriotic occasion, such as the Fourth of July. It should be understood that the bunting need not be three-colored. Instead it may be monochrome, or more or less colored sections. Color schemes other than red, white and blue are also contemplated, and two or more sections of the same color, separated by a contrasting color, may be included. Coloring may run radially rather than circumferentially, or textiles having a plaid or printed pattern may be employed. Although depicted in rectangular shape, the length of textile 100 may comprise any shape feasible in accordance with embodiments of the present invention. For example, the length of textile may comprise a circle, triangle, pentagon, hexagon, octagon, free-form shape, or the like.

Referring again to FIG. 1, exemplary embodiments of the present invention may include a bunting comprising the length of textile 100 that may comprise a top edge 102, a bottom edge 104, a first lateral side 106, and a second lateral side 108. Although depicted as edges forming substantially straight lines, the top edge 102, bottom edge 104, first lateral side 106, and second lateral side 108 may comprise any form or shape, for example, a jagged shape, a wave-like shape, or the like. Generally, the length of textile 100 may be folded about a plurality of fold lines at predetermined lengths into a plurality of pleats. An exemplary fold line 110 is depicted in FIG. 1.

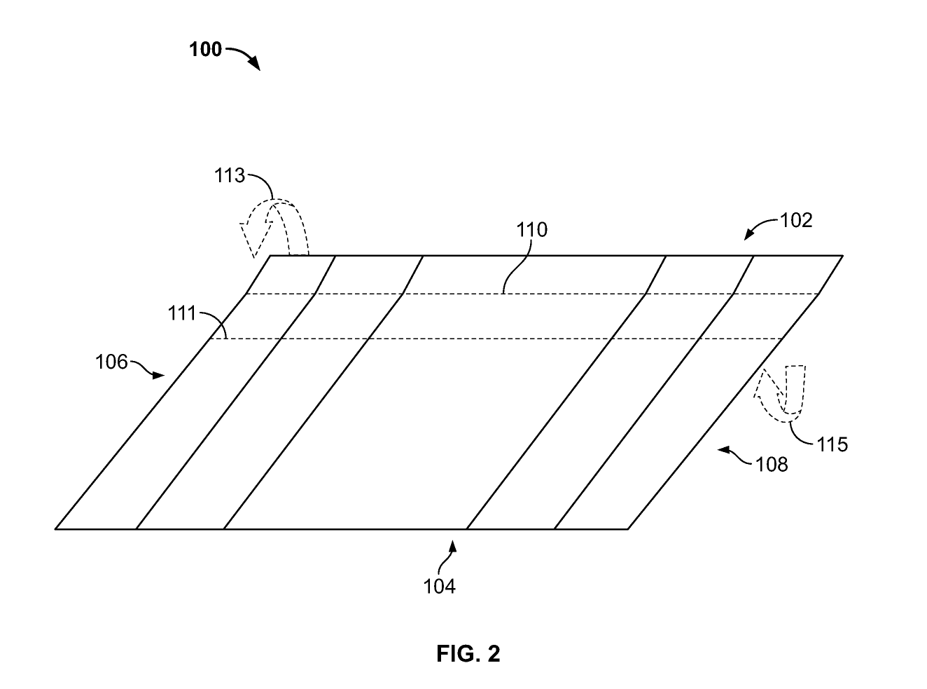

In exemplary embodiments, the lengths of the plurality of pleats may comprise less than half of the distance between the top edge 102 and the bottom edge 104. In exemplary embodiments, the fold line 110 may comprise a pre-made or pre-folded line. In alternative exemplary embodiments, the fold line 110 may not comprise a pre-made or pre-folded line. The fold line 110 may comprise, for example, a substantially straight line. Alternatively, the fold line 110 may comprise any other shape or curvature. In exemplary embodiments, the fold line 110 may be perpendicular to the first lateral side 106 and/or the second lateral side 108. In alternative exemplary embodiments, the fold line 110 may be oriented in any angle or direction relative to the first lateral side 106 and/or the second lateral side 108. An exemplary process of folding the length of the textile 110 to form a plurality of pleats in accordance with exemplary embodiments is depicted in FIG. 2.

FIG. 2 is a perspective view illustrating an exemplary length of textile 100 that may be used to form a bunting in accordance with embodiments of the present invention. The length of textile 100, top edge 102, bottom edge 104, first lateral side 106, second lateral side 108, and the fold line 110 depicted in FIG. 2 may be similar to those described with reference to FIG. 1. In exemplary embodiments, top edge 102 of the length of textile 100 may be folded about the fold line 110 toward the bottom edge 104 in the direction of arrow 113 (shown in phantom to indicate the direction of the fold).

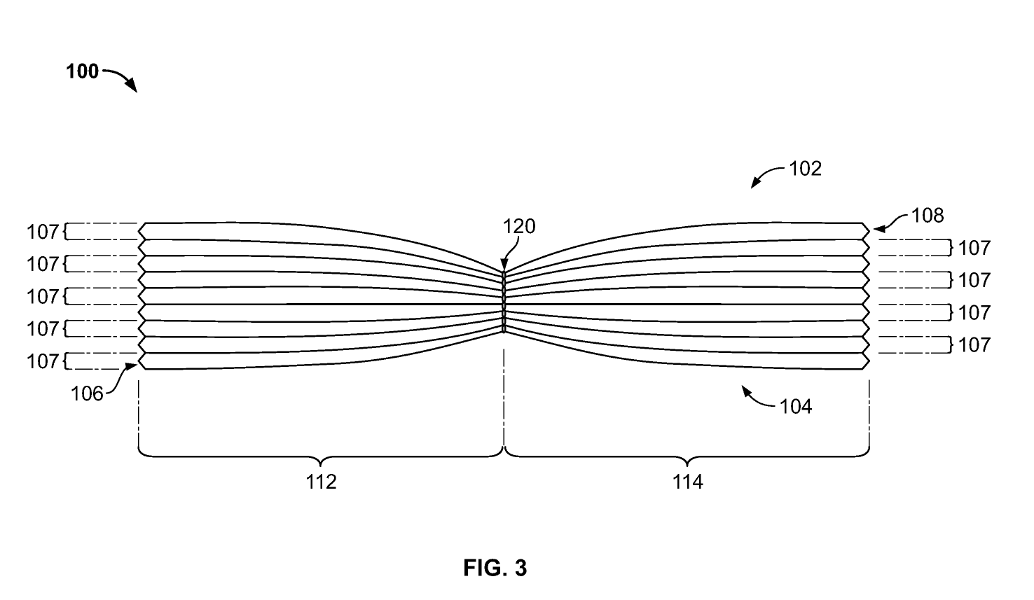

In exemplary embodiments of the present invention, after the top edge 102 is folded about the fold line 110, the folded section may be rotated in an alternating fold toward the bottom edge 104 about a second fold line 111 in a direction of arrow 115 (shown in phantom to indicate the direction of the fold), opposite the original fold direction, forming a plurality of pleats. It is to be understood that the plurality of pleats may be formed in the length of textile 100 by a series of alternating folds, so that the folding operation can be easily accomplished by hand or by machine. In exemplary embodiments, the folding process may continue until the length of textile 100 is completely folded forming a plurality of pleats in a gathered condition. FIG. 3 depicts the length of textile 100 folded in a plurality of pleats (107) in a gathered condition.

FIG. 3 is a perspective view illustrating an exemplary length of textile 100 that may be used to form a bunting, folded into a plurality of pleats 107 in a gathered condition in accordance with embodiments of the present invention. The length of textile 100, top edge 102, bottom edge 104, first lateral side 106, and second lateral side 108 depicted in FIG. 3 may be similar to those described with reference to FIG. 2. In exemplary embodiments, a first coupling member 120 may be adapted to attach each of the plurality of pleats 107 at a location between the first lateral side 106 and the second lateral side 106.

The plurality of pleats 107 may be attached, for example, substantially near a location equidistant between the first lateral side 106 and the second lateral side 108. In exemplary embodiments, the plurality of pleats 107 may be attached at any location on the length of textile 100. For example, the plurality of pleats 107 may be attached at a location closer to the first lateral side 106 than the second lateral side 108, or vice versa.

Although the first coupling member 120 is depicted in FIG. 1 as a single linear attachment, it is contemplated in exemplary embodiments of the present invention that the first coupling member 120 may comprise any number of attachment points, attachment locations, and/or attachment shapes. For example, the first coupling member 120 may comprise two or more attachment points. The first coupling member 120 may generally comprise any attachment means feasible in exemplary embodiments of the present invention. For example the first coupling member 120 may comprise one or more stitches, staples, thermally activated adhesives or polymers (akin to that used for “iron-on” hems), standard glues or other adhesives, polymers or other materials melted/fused together, mechanical fasteners, or the like. In exemplary embodiments wherein the first coupling member 120 may comprise one or more stitches, the stitches may comprise any type of stitch feasible in exemplary embodiments of the present invention. For example, one or more stitches may comprise a straight stitch, an overcast stitch, a zigzag stitch, a satin stitch, a baste stitch, a blanket stitch, a buttonhole stitch, a slip stitch, a chain stitch, a running stitch, a back stitch, a box stitch, a cross stitch, a gather stitch, an overlock stitch, a stay stitch, or the like.

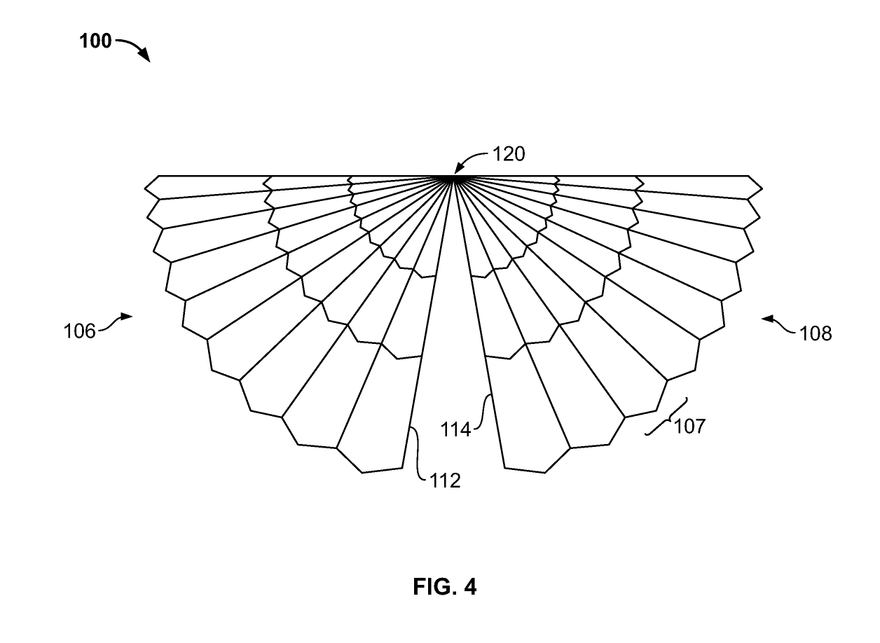

In exemplary embodiments, the bottom edge 104 may comprise a first bottom portion 112 and a second bottom portion 114. Although the first bottom portion 112 and the second bottom portion are depicted in FIG. 3 having substantially equal length, the first bottom portion 112 and the second bottom portion 114 may have any length feasible in exemplary embodiments of the present invention. The length of the first bottom portion 112 and the second bottom portion 114 may generally be dependent upon the location of the first coupling member 120. For example, if the first coupling member 120 is attached closer to the first lateral side 106 than the second lateral side 108, the second bottom portion 114 will comprise a greater length than the first bottom portion 112, and vice versa. In exemplary embodiments of the present invention, the first bottom portion 112 and the second bottom portion 114 may be rotated inwardly so that the plurality of pleats 107 may unfold about the first coupling member 120 forming a fan-like structure. An exemplary textile 100 in a semi-expanded position is depicted in FIG. 4.

FIG. 4 is a perspective view illustrating an exemplary length of textile 100 that may be used to form a bunting, folded to form a plurality of pleats 107 in a semi-expanded position in accordance with embodiments of the present invention. The length of textile 100, first lateral side 106, second lateral side 108, plurality of pleats 107, first bottom portion 112, second bottom portion 114, and first coupling member 120 depicted in FIG. 4 may be similar to those described with reference to FIG. 3. For purposes of simplicity and clarity, one pleat is labeled in FIG. 4 so as not to obscure the illustration. However, it will be understood that the exemplary length of textile 100 depicted in FIG. 4 may comprise any number of pleats 107.

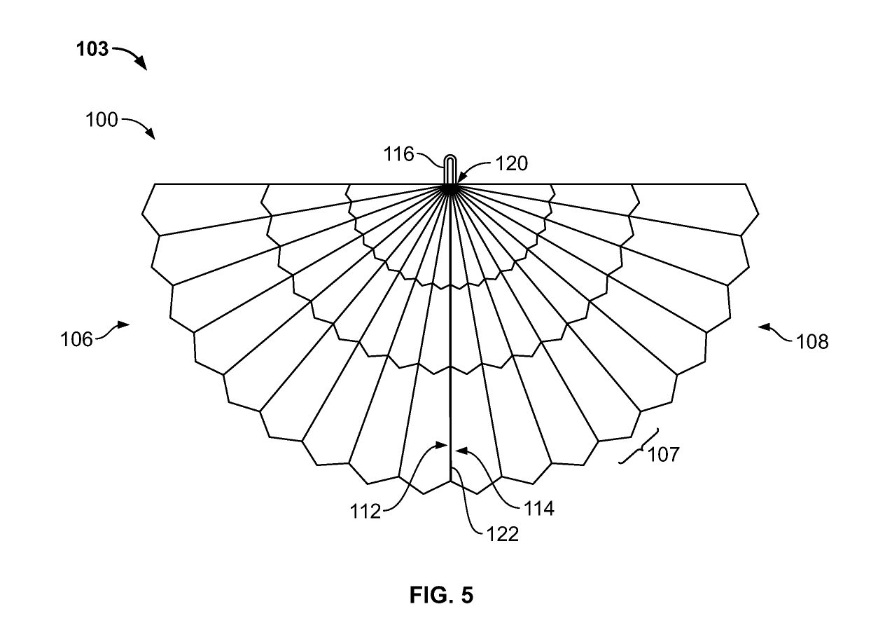

In exemplary embodiments, the first bottom portion 112 and the second bottom portion 114 may be rotated about the first connection means 120 and moved toward each other such that the length of textile 110 may form a fan-like structure. Although depicted in the shape of a fan, the exemplary length of textile 100 may be unfolded to form any other shapes feasible in exemplary embodiments of the present invention. In exemplary embodiments, the first bottom portion 112 and the second bottom portion 114 may be unfolded and meet at least a point. To complete an exemplary bunting, the first bottom portion 112 and the second bottom portion 114 may generally be attached with a second coupling member 122, as depicted in FIG. 5.

FIG. 5 is a perspective view illustrating an exemplary bunting 103 in accordance with exemplary embodiments of the present invention. The length of textile 100, first lateral side 106, second lateral side 108, plurality of pleats 107, first bottom portion 112, second bottom portion 114, and first coupling member 120 depicted in FIG. 5 may be similar to those described with reference to FIG. 4. In exemplary embodiments, the first bottom portion 112 and the second bottom portion 114 may be extended to meet at a point, forming a diameter of a semi-circle created by the first lateral side 106 and the second lateral side 108.

Generally, the first bottom portion 112 and the second bottom portion 114 may be joined at a point and attached with a second coupling member 122. The second coupling member 122 may generally comprise any attachment means feasible in accordance with exemplary embodiments of the present invention. For example the second coupling member 122 may comprise one or more stitches, staples, thermally activated adhesives or polymers (akin to “iron-on” hems), standard glues or other adhesives, polymers or other materials melted/fused together, mechanical fasteners, or the like. In exemplary embodiments wherein the second coupling member 122 may comprise one ore more stitches, the stitches may comprise any type of stitch feasible in exemplary embodiments of the present invention. For example, one or more stitches may comprise a straight stitch, an overcast stitch, a zigzag stitch, a satin stitch, a baste stitch, a blanket stitch, a buttonhole stitch, a slip stitch, a chain stitch, a running stitch, a back stitch, a box stitch, a cross stitch, a gather stitch, an overlock stitch, a stay stitch, or the like.

In exemplary embodiments, the first bottom portion 112 and the second bottom portion 114 may be attached at any location on the first bottom portion 112 and the second bottom portion 114. Although the second coupling member 122 is depicted in FIG. 5 as a single linear attachment, it is contemplated in exemplary embodiments of the present invention that the second coupling member 122 may comprise any number of attachment points, attachment locations, and/or attachment shapes.

Referring again to FIG. 5, in exemplary embodiments, the bunting 103 may comprise a hanger member 116 adapted to support the weight of the bunting 103. The hanger member 116 may generally be adapted to be affixed to any location on the length of textile 100. For example, the hanger member 116 may be attached to at least one of the plurality of pleats 107. Although depicted as a loop, it is contemplated in exemplary embodiments that the hangar member 116 may include any means of hanging feasible in embodiments of the present invention. For example, the hangar member 116 may comprise a hook, a single strip of a material, or the like. Although one hanger member 116 is depicted in FIG. 5, it is contemplated that any number of hanger members 116 and any number of attachment locations feasible in exemplary embodiments of the present invention are contemplated. For example, two or more hanger members 116 may be attached at the same or different locations on the length of textile 100.

In exemplary embodiments, the hangar member 116 may comprise the same material as the length of textile 100 and may comprise any color. In alternative exemplary embodiments, the hangar member 116 may comprise any material capable of supporting the weight of the bunting 103 such as, for example, a textile, string, leather, wood, glass, fiberboard, bioplastic, paper, or the like. It will be appreciated that any means by which the bunting 103 may be mounted to any surface such as, for example, a railing or a wall, is contemplated in exemplary embodiments.

It will be understood that the bunting is shown in FIG. 5 in a spread-open condition suitable for mounting as an ornament. In exemplary embodiments, the bunting 103 may be closed or folded in a condition suitable for storage or shipment. It will be understood that the bunting 103 may be transformed from its opened condition to its closed condition by gathering and folding together the plurality of pleats 107 so that the bunting 103 may exhibit a substantially square or rectangular cross section.

In exemplary embodiments, the ornamental aspects of the bunting 103 can be selected for aesthetic value. In exemplary embodiments, the ornamental bunting 103 provided in accordance with the invention may be a particularly decorative item that can be manufactured efficiently and inexpensively and can be easily placed in a folded condition for storage or shipment. The first coupling member 120 and the second coupling member 122 generally may be attached in a manner as to improve the aesthetic value of the bunting 103.

In exemplary embodiments, a bunting kit (not shown) may comprise a securing band adapted to secure a bunting 103 in a gathered condition wherein the plurality of pleats 107 are folded. By way of example, a securing band may comprise any material adapted to secure the textile 100 in a gathered condition. For example, a securing band may comprise a rubber band, string, rope, plastic tie, or the like.

In exemplary embodiments, the bunting 103 shown in FIG. 5 may be folded into a closed or folded condition suitable for storage or shipment and secured with a securing band. It will be understood that the bunting 103 can be transformed from its closed condition to its open condition by removing the securing band and unfolding the plurality of pleats 107 so that the bunting 103 exhibits a substantially semi-circular shape (FIG. 5). Because the plurality of pleats 107 of the bunting 103 may be formed of regular alternating right and left folds, it may be easy to unfold the plurality of pleats 107 to transform the bunting 103 from its closed position to its open position.

In exemplary embodiments, one or more hanging apertures (not shown) may be installed on one or more of the plurality of pleats 107. Generally, the one or more hanging apertures may be adapted to receive fasteners such as nails, tacks or wires, by means of which the bunting 103 may be mounted to a railing or to a surface such as a wall. In exemplary embodiments, the one or more hanging apertures may include grommets, eyelets, or the like. Any number of hanging apertures may be feasible in exemplary embodiments. In addition, the one or more hanging apertures may be placed in any location on the bunting 103 feasible in exemplary embodiments.

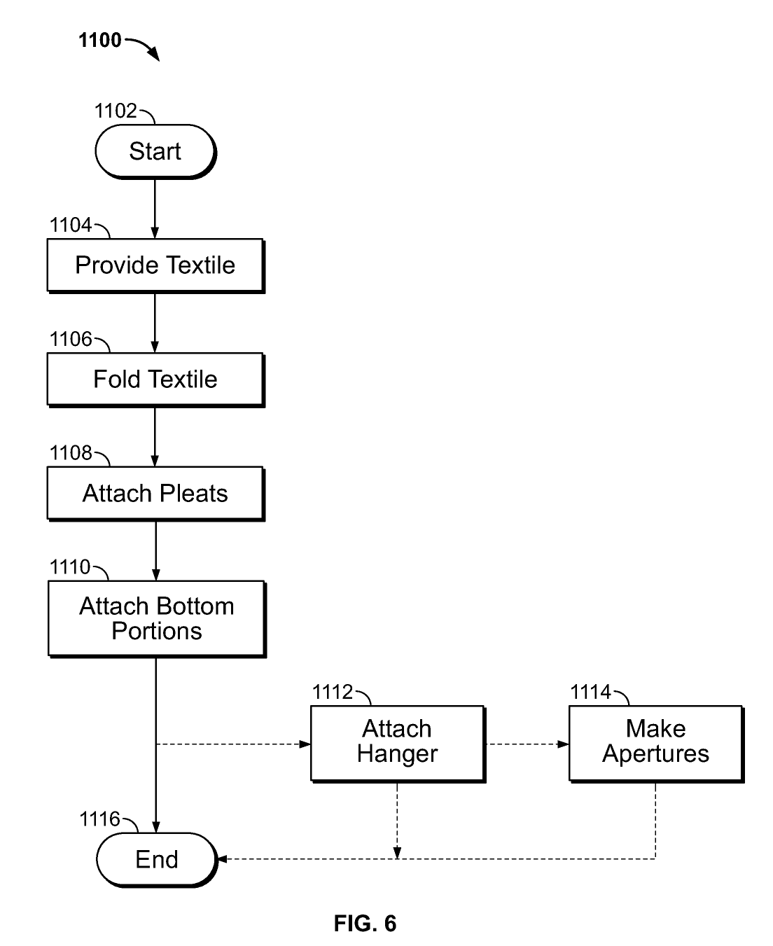

FIG. 6 is a flow diagram illustrating an example flow 1100 for carrying out exemplary embodiments of the present invention. A bunting in accordance with exemplary embodiments may be manufactured by following the steps of example flow 1110. For convenience, the flow 1100 of FIG. 6 is described with reference to the length of textile 100 and the bunting 103 of FIGS. 1-5. The flow 1110 may be carried out using other embodiments as well.

In exemplary embodiments, the flow may start at process block 1102 and transition to process block 1104. In exemplary embodiments, at process block 1104, a length of a textile 100 may be provided. The length of textile 100 may generally comprise, for example, a top edge 102 and a bottom edge 104. The bottom edge 104 may generally comprise, for example, a first bottom portion 112 and a second bottom portion 114. In exemplary embodiments, after process block 1104, the flow 1100 may transition to process block 1106.

In exemplary embodiments, at process block 1106 the length of textile 100 may be folded into a plurality of pleats 107. The folding process may be completed, for example, by hand, with the use of mechanical or electromechanical means, any combination thereof, or the like. In exemplary embodiments, the plurality of pleats 107 are folded and placed in a gathered position. After process block 1106, the flow 1100 may transition to process block 1108.

In exemplary embodiments, the plurality of pleats 107 are attached between the first lateral side 106 and the second lateral side 108 with a first coupling member 120. The first coupling member 120 may be attached, for example, by hand, with the use of mechanical or electromechanical means, any combination thereof, or the like. In exemplary embodiments, the first bottom portion 112 and the second bottom portion 114 may be expanded, unfolding the plurality of pleats 107 about the first coupling member 120. After process block 1108, the flow 1100 may transition to process block 1110.

In exemplary embodiments, the first bottom portion 112 of the bottom edge 104 and the second bottom portion 114 of the bottom edge 104 may be attached with a second coupling member 122. In exemplary embodiments, the first bottom portion 112 and the second bottom portion 114 may be expanded to meet at a point, forming a diameter of a semi-circle created by the first lateral side 106 and the second lateral side 108. The second coupling member 122 may be attached, for example, by hand, with the use of mechanical or electromechanical means, any combination thereof, or the like. In exemplary embodiments, after process block 1110 the flow 1100 may transition to process block 1116, where the flow may be terminated.

In alternative exemplary embodiments, after process block 1110, the flow may transition to optional process block 1112. In exemplary embodiments, at optional process block 1112, a hanger member 116 may be attached. The hanger member 116 may be attached, for example, by hand, with the use of mechanical or electromechanical means, any combination thereof, or the like. In exemplary embodiments, after optional process block 1112 the flow may transition to process block 1116, where the flow 1100 may be terminated.

In alternative exemplary embodiments, after optional process block 1112, the flow may transition to optional process block 1114. In alternative exemplary embodiments, the flow may transition to optional process block 1114 from process block 1110. In exemplary embodiments, at optional process block 1114, hanging apertures may be made in the bunting 103. The hanging aperture may be made, for example, by hand, with the use of mechanical or electromechanical means, any combination thereof, or the like. In exemplary embodiments, after process block 1114 the flow may transition to process block 1116, where the flow 1100 may be terminated.

It will be understood that any of the steps described can be rearranged, separated, and/or combined without deviating from the scope of embodiments of the invention. For ease, steps are, at times, presented sequentially. This is merely for ease and is in no way meant to be a limitation.

Further, it will be understood that any of the elements and/or exemplary embodiments of the invention described can be rearranged, separated, and/or combined without deviation from the scope of the invention. For ease, various elements are described, at times, separately. This is merely for ease and is in no way meant to be a limitation.

While the various steps, elements, and/or exemplary embodiments of the invention have been outlined above, it is evident that many alternatives, modifications and variations will be apparent to those skilled in the art. The various steps, elements, and/or exemplary embodiments of the invention, as set forth above, are intended to be illustrative, not limiting. Various changes may be made without departing from the spirit and scope of the invention. Accordingly, the spirit and scope of the present invention is to be construed broadly and limited only by the appended claims and not by the foregoing specification.

No element, act, or instruction used in the description of the present application should be construed as critical or essential to the invention unless explicitly described as such. Also, as used herein, the article “a” is intended to include one or more items. Where only one item is intended, the term “one” or similar language is used.

Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. In addition, as used herein, the term “set” is intended to include any number of items, including zero. Further, as used herein, the term “number” is intended to include any number, including zero.

What is claimed is:

1. A bunting, comprising:
a length of textile folded to form a plurality of pleats, the length of textile comprising a top edge, a bottom edge, a first lateral side, and a second lateral side;
a first coupling member adapted to attach each of the plurality of pleats at a location between the first lateral side and the second lateral side; and
a second coupling member adapted to attach a first bottom portion of the bottom edge with a second bottom portion of the bottom edge.

2. The bunting of claim 1, wherein the plurality of pleats are attached substantially near a location equidistant between the first lateral side and the second lateral side.

3. The bunting of claim 1,wherein the first bottom portion of the bottom edge is attached to the second bottom portion of the bottom edge at a plurality of locations along a line, wherein the length of the line is less than half the length of the bottom edge.

4. The bunting of claim 1, wherein at least one of the first coupling member and the second coupling member comprises a plurality of stitches.

5. The bunting of claim 1, further comprising:
a hanger member adapted to support the weight of the bunting, the hanger member attached to at least one of the plurality of pleats.

6. The bunting of claim 1, wherein the textile comprises a plurality of sections of textile attached together.

7. The bunting of claim 6, wherein at least two of the plurality of sections of textile comprise different colors.

8. A method of manufacturing a bunting, comprising:
providing a length of a textile including a top edge, a bottom edge, the bottom edge comprising a first bottom portion and a second bottom portion;
folding the length of textile into a plurality of pleats, the plurality of pleats including a first lateral side and a second lateral side;
attaching each of the plurality of pleats between the first lateral side and the second lateral side with a first coupling member; and
attaching the first bottom portion of the bottom edge and the second bottom portion of the bottom edge with a second coupling member.

9. The method of claim 8, wherein the plurality of pleats are attached substantially near a location equidistant between the first lateral side and the second lateral side.

10. The method of claim 8, wherein the first bottom portion of the bottom edge is attached to the second bottom portion of the bottom edge at a plurality of locations along a line, the line less than half the length of the bottom edge.

11. The method of claim 8, wherein at least one of the first coupling member and the second coupling member comprises a plurality of stitches

12. The method of claim 8, further comprising:
attaching hanger member adapted to support the weight of the bunting to at least one of the plurality of pleats.

13. The method of claim 8, wherein the textile comprises a plurality sections of textile attached together.

14. The method of claim 13, wherein at least two of the plurality of sections of textile comprise different color.

15. A bunting kit, comprising:
a length of textile folded to form a plurality of pleats, the length of textile comprising a top edge, a bottom edge, a first lateral side, and a second lateral side;
a first coupling member adapted to attach each of the plurality of pleats at a location between the first lateral side and the second lateral side;
a second coupling member adapted to attach a first bottom portion of the bottom edge with a second bottom portion of the bottom edge;
a hanger member adapted to support the weight of the bunting, the hanger member attached to the length of textile; and
a securing band adapted to secure the length of textile in a gathered condition wherein the plurality of pleats are folded.

16. The bunting kit of claim 15, wherein the plurality of pleats are attached substantially near a location equidistant between the first lateral side and the second lateral side.

17. The bunting kit of claim 15, wherein the first bottom portion of the bottom edge is attached to the second bottom portion of the bottom edge at a plurality of locations along a line, the line less than half the length of the bottom edge.

18. The bunting kit of claim 15, wherein at least one of the first coupling member and the second coupling member comprises a plurality of stitches.

19. The bunting kit of claim 15, wherein the textile comprises a plurality sections of textile attached together.

20. The bunting kit of claim 15, wherein the securing band comprises at least one of a string and a rubber band.
